(19) United States
(12) Patent Application Publication
(10) Pub. No.: US 2026/0081695 A1
(43) Pub. Date: Mar. 19, 2026

(54) CANTILEVER CONSTRAINING FEATURE FOR OPTICAL TRANSCEIVER MODULE

(71) Applicant: Cisco Technology, Inc., San Jose, CA (US)

(72) Inventors: Matthew Andrew LOS, Carlsbad, CA (US); Mark PETERSON, San Diego, CA (US); Stephan GOSTONYI, Whitehall, PA (US); Ryan T. EHID, Philadelphia, PA (US); Mittu PANNALA, Breinigsville, PA (US)

(21) Appl. No.: 18/888,450

(22) Filed: Sep. 18, 2024

(51) Int. Cl. H04B 10/40; G02B 6/12; G02B 6/38; G02B 6/42

(52) U.S. Cl. CPC H04B 10/40; G02B 6/12004; G02B 6/3814; G02B 6/4292

(57) ABSTRACT

In one embodiment, an apparatus includes an upper housing, a lower housing couplable to the upper housing, and an optical-electrical assembly enclosed by the upper housing and the lower housing. The optical-electrical assembly includes a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits. The apparatus further includes a pull handle mechanism coupled to the slide component. The cantilever mechanism is configured to cause the slide component to stop at a fixed location when the slide component is engaged with the lower housing.

### TECHNICAL FIELD

The present disclosure relates generally to computer networks, and, more particularly, to a cantilever constraining feature for an optical transceiver module.

### BACKGROUND

Optical-electrical assemblies, such as optical transceivers, are interconnect components that can transmit and receive data. Optical transceivers generally rely on the use of wavelength-specific lasers that convert electrical data signals from data switches into optical signals. These signals can then be transmitted over an optical fiber. Although optical transceivers are used in most industries, they are of utmost importance in telecom applications due to their ability to transport high levels of data over a network.

In general, optical transceivers are modular units that can be subjected to insertion and/or removal at various stages of their work life. For example, components of optical transceivers may be subjected to a series of debugging tests prior to final assembly, and these tests can involve a series of insertions and removals of various components associated with the optical transceiver. Further, once deployed in the field, an optical transceiver may require further insertion and/or removal operations such as in scenarios where the optical transceiver may need to be plugged into a different port or other receiving receptacle. In such scenarios, an optical receiver may be subjected to “hot swapping” operations whereby the optical transceiver is inserted and/or removed from a device that is in operation (e.g., in a power on state).

In order to facilitate insertion and/or removal of an optical transceiver from a device to which the optical transceiver is couplable, many optical transceivers feature a “pull-tab” that, when a human operator interacts with such a pull-tab, allows removal and/or insertion of the optical transceiver from the device. In general, these pull-tab mechanisms can provide mechanical features to constrain the pull-tab component on the body of the product, while allowing the translation/sliding motion required for the functionality of the optical transceiver. However, to situate the pull-tab in place, or remove it, the top shell of the hosting enclosure is generally disposed at an angle of insertion, which can complicate the assembly process.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate schematic structural diagrams of an example optical-electrical assembly;

FIG. 2 illustrates a schematic structural diagram of a portion of a side of the example optical-electrical assembly;

FIG. 3 illustrates a schematic structural diagram of a slide component including a cantilever mechanism coupled to a pull handle mechanism associated with the optical-electrical assembly;

FIGS. 4A-4B illustrate schematic structural diagrams of a bottom view of the cantilever mechanism;

FIG. 5 illustrates a schematic structural diagram of a top view of the cantilever mechanism; and

FIG. 6 illustrates an example procedure for a cantilever constraining feature for an optical transceiver module.

### DESCRIPTION OF EXAMPLE EMBODIMENTS

### Overview

According to one or more embodiments of the disclosure, an apparatus includes an upper housing, a lower housing couplable to the upper housing, and an optical-electrical assembly enclosed by the upper housing and the lower housing. The optical-electrical assembly includes a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits. The apparatus further includes a pull handle mechanism coupled to the slide component. The cantilever mechanism is configured to cause the slide component to stop at a fixed location when the slide component is engaged with the lower housing.

Other implementations are described below, and this overview is not meant to limit the scope of the present disclosure.

### Description

In describing the present disclosure, it should be understood that the terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” “axial,” “radial,” “circumferential,” and other indicated orientations or positional relationships are based on the orientations or positional relationships shown in the drawings, which are only for the convenience of describing the present disclosure and simplifying the description, rather than indicating or implying the referred device or elements must have certain orientations, be constructed and operate in certain orientations, and therefore should not be construed as limitations on the invention.

In addition, the terms “first” and “second” are used for descriptive purposes only, and cannot be interpreted as indicating or implying relative importance or implicitly specifying the quantity of indicated technical features. Thus, the features defined as “first” and “second” may explicitly or implicitly include at least one of these features. In the description of the present invention, “plurality” means at least two, such as two, three, etc., unless otherwise specifically defined.

Further, in the present disclosure, unless otherwise clearly specified and limited, terms such as “installation,” “connection,” and “fixation” should be understood in a broad sense, for example, it can be a fixed connection or a detachable connection, or integrated; it may be mechanically connected or electrically connected; it may be directly connected or indirectly connected through an intermediary, and it may be the internal communication of two components or the interaction relationship between two components, unless otherwise specified limited. Those of ordinary skill in the art can understand the specific meanings of the above terms in the present invention according to specific situations.

In the present disclosure, unless otherwise clearly specified and limited, the first feature may be in direct contact with the first feature or the first and second feature may be in direct contact with the second feature through an intermediary. Moreover, “above” the first feature on the second feature may mean that the first feature is directly above or obliquely above the second feature or may simply mean that the first feature is higher in level than the second feature. “Below” and “beneath” the first feature may mean that the first feature is directly below or obliquely below the second feature or may simply mean that the first feature is less horizontally than the second feature. It should further be noted that when an element is referred to as being “fixed on” or “disposed on” another element, it may be directly on the other element or there may be an intervening element. When an element is referred to as being “connected to” or “coupled to” another element, it can be directly connected to the other element or intervening elements may also be present.

### Cantilever Constraining Feature for an Optical Transceiver Module

As noted above, optical transceivers are modular units that can be repeatedly subjected to insertion and/or removal at various stages of their work life. As also noted above, in order to facilitate insertion and/or removal of an optical transceiver from a device to which the optical transceiver is couplable, many optical transceivers feature a “pull-tab” that, when a human operator interacts with such a pull-tab, allows removal and/or insertion of the optical transceiver from the device. As mentioned, these pull-tab mechanisms can provide mechanical features to constrain the pull-tab component on the body of the product, while allowing the translation/sliding motion required for the functionality of the optical transceiver. However, to situate the pull-tab in place, or remove it, the top shell of the hosting enclosure is generally disposed at an angle of insertion, which can complicate the assembly process.

Further, it may be beneficial to provide access to components of the optical transceivers that are housed in for various purposes, such as for debugging, repair, and/or to replace the internal components of the optical transceiver. However, current approaches generally do not allow for easy access to the internal components (e.g., components that are housed within an enclosure associated with the optical transceiver) and, as such, can rely on opening the enclosure to gain access to the internal components of the optical transceiver.

In contrast, implementations described herein provide for an optical-electrical assembly that includes a cantilever feature within the sheet-metal portion of the pull-tab to provide a hard-stop at an area that takes up minimal real-estate in critical areas on the slender sides of the module. As discussed in more detail herein, the optical-electrical assembly of the disclosure enables additional benefits, such as:
allowing for a single split line across the two halves of the module body (e.g., the module enclosure) that creates optimal contact for electromagnetic compatibility (EMC) against manufacturing variability;
allowing for complex die-casting geometries, such as undercuts to reference the pull-tab in a hard stop to be avoided;
allowing the pull-tab to be assembled and disassembled when the two halves of the module enclosure is in place (e.g., without opening the module body); and
allowing for a linear insertion of the pull-tab during process assembly.

As discussed in more detail below, to engage the pull-tab (e.g., to couple or decouple the pull-tab and associated components to the optical-electrical assembly) in accordance with implementations described herein, a cantilever mechanism can deflect to allow for the locking mechanism move into place. This engagement can be achieved during an initial insertion to allow the cantilever hard-stop feature to move out of the way and then drag across the surface of the enclosure until the cantilever mechanism falls into place.

As discussed in more detail herein, the mechanical features of the disclosure allow for the following:
1) installation of the pull-tab, which, in previous approaches could require insertion at a particular angle to align into or around key locating features without requiring a user to align the pull-tab at such angles;
2) constraining the pull-tab in all degrees of freedom, except the translation (e.g., horizontal sliding) motion, so that the optical-electrical component is robustly held in place throughout its use;
3) providing a hard-stop to end the translation/sliding motion, so that the optical-electrical component meets the design requirements; and
4) incorporation of features that include springs so that the optical-electrical component is energized in an activated (e.g., engaged) position and not energized in an inactivated (e.g., disengaged) position.

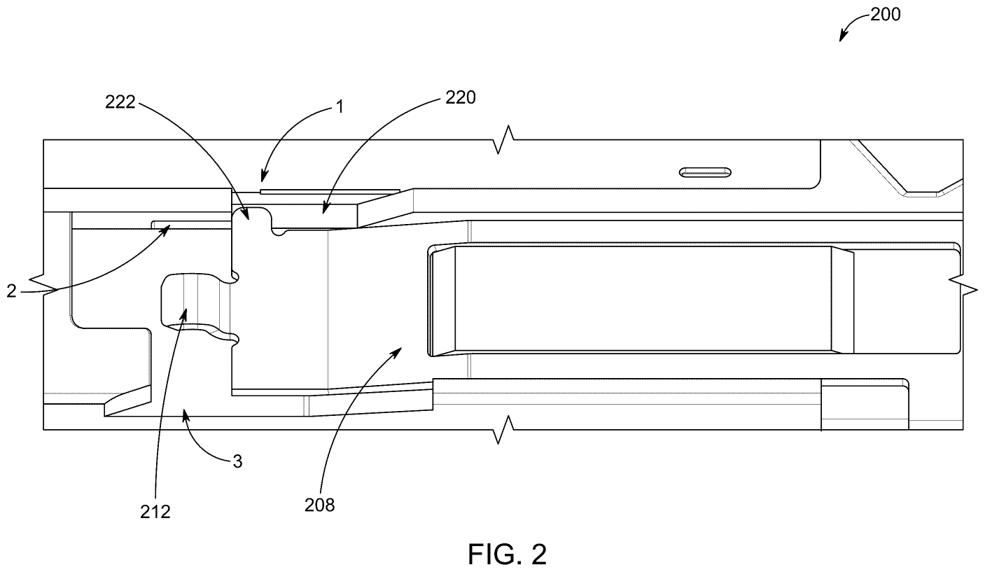

For number 3) above, in particular, a vertical tab extending off the slender pull-tab mechanisms arms is typically used to create a hard-stop with the die-cast enclosure (indicated by the arrow “1” in FIG. 2). In some approaches, this vertical tab can be what creates the difficulty in number 1) above, and secondly the manufacturing challenges that come with the complex design geometry to reference this tab for the hard-stop functionality, such as undercuts in the mold design. Accordingly, and in some approaches, in order to situate this pull-tab in place, or remove it, the upper housing (e.g., the top shell of the hosting enclosure) of the enclosure may require removal and some angle of insertion in place is required, creating complexity in the assembly process.

The other arrows shown in FIG. 2 (e.g., the arrow “2” and the arrow “3”) illustrate some of the other complicated geometries present in some approaches that can complicate the manufacturing process, as well as installation and/or removal processes. Further, as shown below in FIG. 2, in some approaches the vertical tab (indicated by the arrow “1”) provides the hard stop for the optical-electrical component. More specifically, in some approaches, the metal tab at the arrow “1” is typically interfaced with a surface of the housing to stop motion of the optical-electrical component in the horizontal direction. However, if the metal arms are allowed to translate to the right (e.g., horizontally to the right in FIG. 2), there may not be a surface to actually stop this motion, which can lead to the optical-electrical component becoming dislodged.

In order to address this issue, implementations described herein allow for the removal of the stopping surface of previous approaches and instead relocate the stopping surface to the tip of the cantilever mechanism. However, in some implementations, the vertical tab indicated by the arrow “1” of FIG. 2 is retained in order to constrain the pull-tab arms in-plane by using the channel indicated by the arrow “2” of FIG. 2. As discussed in more detail herein, the travel distance in nominal “home position” is then referenced by the arrow “3”shown in FIG. 2.

The techniques herein therefore provide for a cantilever mechanism that creates a hard-stop for a sliding mechanism (e.g., a slide component) used on an optical-electrical component, such as an optical transceiver module. This and other features of the present disclosure can reduce complexity in enclosure design of mating components, free up critical real estate in the mechanical enclosure of the optical-electrical component and allow for assembly and/or disassembly of the mechanism (e.g., access to components located inside the enclosure) when the enclosure is assembled.

Specifically, according to one or more embodiments of the disclosure as described in detail below, an apparatus includes an upper housing, a lower housing couplable to the upper housing, and an optical-electrical assembly enclosed by the upper housing and the lower housing. The optical-electrical assembly includes a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits. The apparatus further includes a pull handle mechanism coupled to the slide component. The cantilever mechanism is configured to cause the slide component to stop at a fixed location when the slide component is engaged with the lower housing.

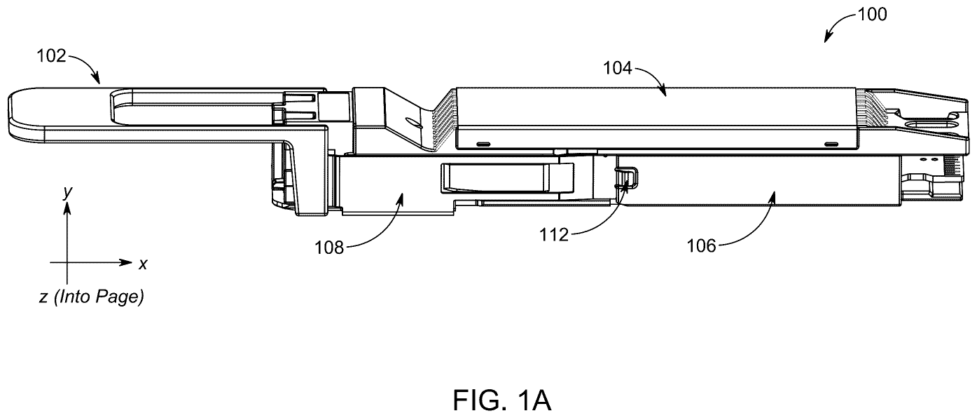

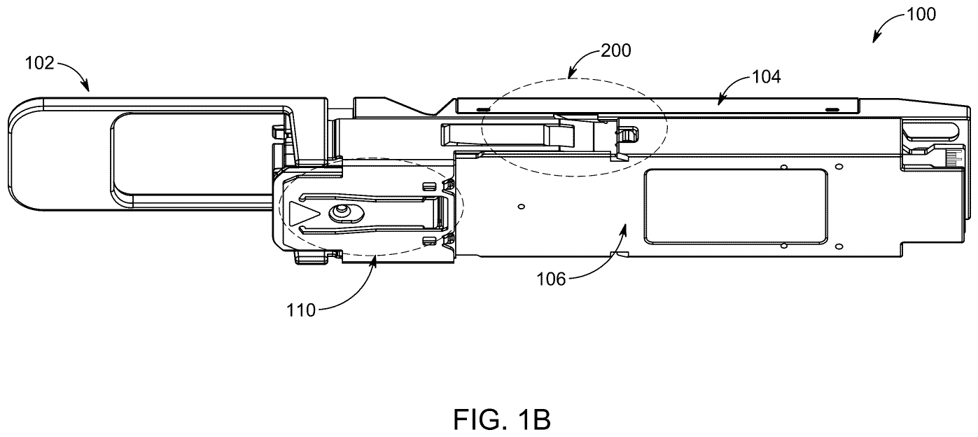

Operationally, FIGS. 1A-1B illustrate schematic structural diagrams of an example optical-electrical assembly. FIG. 1A shows a side view of the optical-electrical assembly 100, while FIG. 1B shows a view of the optical-electrical assembly 100 that is rotated to show a bottom view of the optical-electrical assembly 100. In some implementations, the optical-electrical assembly 100 can be an optical transceiver or other similar interconnect component that can transmit and receive data.

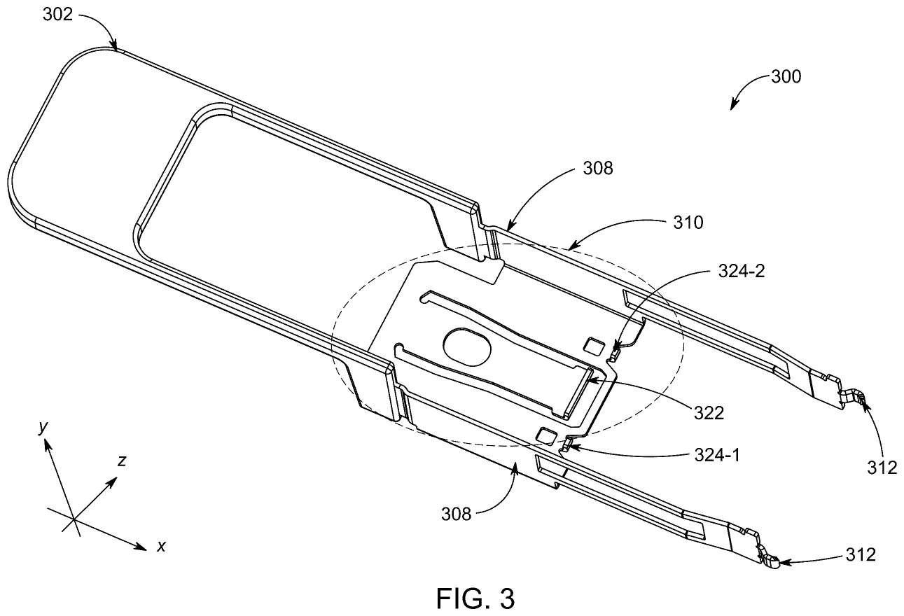

As shown in FIGS. 1A-1B, the optical-electrical assembly 100 includes a pull handle mechanism 102 (which may be referred to in the alternative herein as a “pull-tab”), which is coupled to a pair of engagement arms 108. As shown in FIG. 1A the pair of engagement arms 108 include a pair of tabs 112. It is noted that a single engagement arm and a single tab are visible in FIGS. 1A-1B, however, it will be appreciated that the second engagement arm and the second tab of the pair of engagement arms 108 and the pair of tabs 112 are located on the opposite side of the optical-electrical assembly 100. In addition, these features are illustrated in FIG. 3, herein.

The optical-electrical assembly 100 further includes an upper housing 104 and a lower housing 106. The upper housing 104 and the lower housing 106 can couple to one another to form an enclosure for components associated with the optical-electrical assembly.

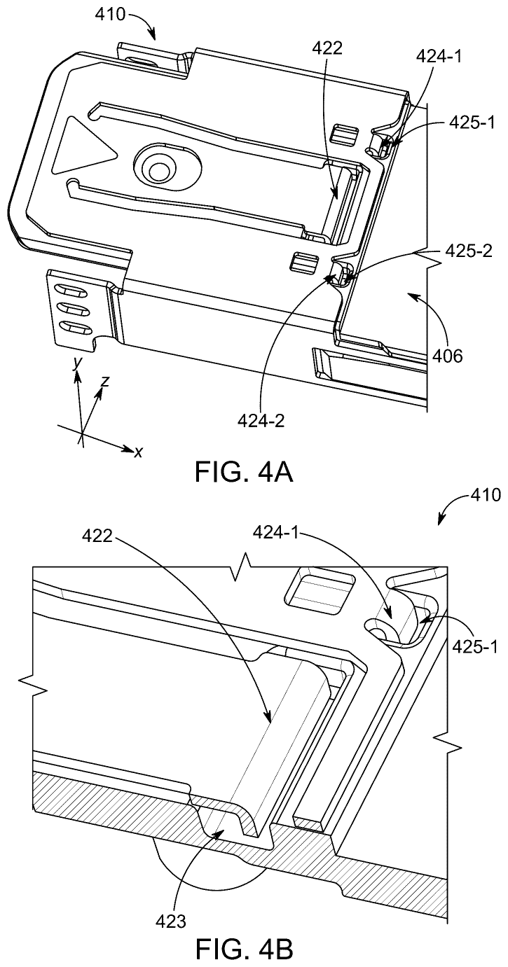

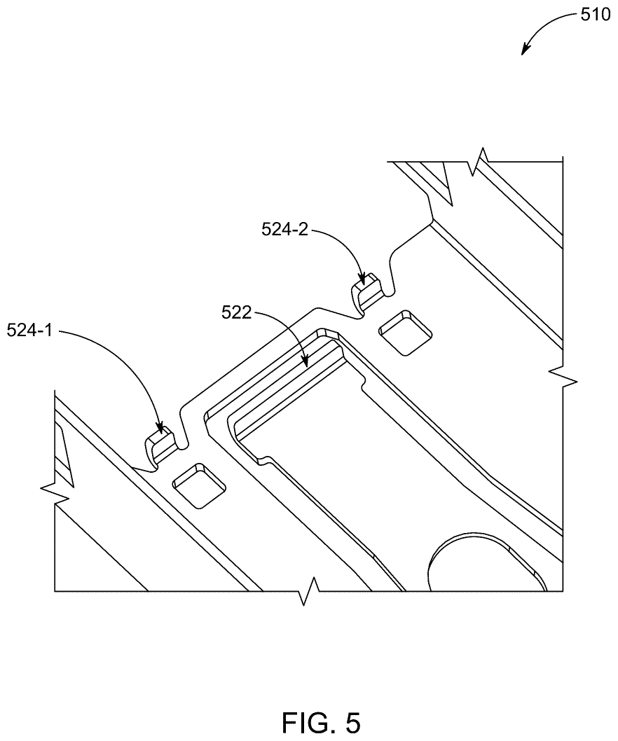

Further, as shown in FIG. 1B, the optical-electrical assembly 100 can include a cantilever mechanism 110, which is described in more detail in connection with FIG. 4A, FIG. 4B, and FIG. 5, herein. It is also noted that the region 200 shown in FIG. 1B is shown as the region 200 in FIG. 2 and is discussed in more detail in connection with FIG. 2, herein.

In some implementations, the pull handle mechanism 102 is physically coupled to the pair of engagement arms 108. The pair of engagement arms 108 can be fabricated from a metal material, while the pull handle mechanism 102 can be fabricated from plastic, rubber, or other similar material. Implementations are not, however, limited to these example materials. In addition, as shown in more detail in FIG. 3, the cantilever mechanism 110 is built into the material that includes the pair of engagement arms 108. That is, in some implementations, the pair of engagement arms 108, the cantilever mechanism 110, and the pair of tabs 112 can be formed as a single piece from a same material and this single piece that can be referred to herein as a “slide mechanism.” In some implementations, the slide mechanism can be coupled to the pull handle mechanism 102 to form a single component (formed of the slide mechanism and the pull handle mechanism), which can be referred to herein as a “pull-tab mechanism,” which is illustrated in FIG. 3 as the pull-tab mechanism 300.

The pull-tab mechanism can be removed from the enclosure formed by the upper housing 104 and the lower housing 106 without opening the enclosure. That is, in some implementations, the pull handle mechanism 102 can be actuated to remove the slide mechanism, as well as any components coupled thereto, from the enclosure without disassembling the enclosure by removing the upper housing 104 from the lower housing 106.

In some implementations, the components that can be coupled to the slide mechanism and can therefore be removed from the enclosure by actuating the pull handle mechanism 102 can include opto-electric components that are disposed on a substrate that can be coupled to the slide mechanism. Non-limiting examples of such opto-electrical components can include a Transmit Optical Sub-Assembly (TOSA), a Receive Optical Sub-Assembly (ROSA), one or more heat spreading components, functional circuit components, optical bores, laser diodes, light-emitting diodes, photodetector diodes, an in-module gearbox, in-module forward error correction components, high bandwidth integrated polarization multiplexed quadrature modulators, integrated polarization multiplexed quadrature modulated transmitters, and/or integrated dual polarization micro-intradyne coherent receivers, among other possible opto-electrical components.

In some implementations, the pull handle mechanism 102 is actuated along x-axis to insert or remove the slide mechanism from the housing. Accordingly, it may be beneficial to minimize or eliminate degrees of freedom associated with the pull-tab mechanism along the y-axis and the z-axis. In order to achieve this, a tab (e.g., the vertical tab 222 of FIG. 2) can be provided such that, when the pull-tab mechanism is inserted into the housing, the motion of the pull-tab mechanism is constrained along the y-axis and along the z-axis.

In addition, it may be beneficial to constrain the movement of the pull-tab mechanism along the x-axis when the pull-tab mechanism is inserted in the housing while still allowing for removal of the pull-tab mechanism via actuation of the pull handle mechanism 102. In order to facilitate this, the cantilever mechanism 110 can be flexible enough to deflect a given amount along the y-axis during insertion and removal of the pull-tab mechanism. As discussed in more detail below, the cantilever mechanism 110 can, subsequent to deflecting for insertion or removal, return to a position that allows the cantilever mechanism 110 to couple to a portion of the lower housing 106 thereby coupling the pull-tab mechanism to the housing.

In some implementations, the cantilever mechanism 110 can assist in constraining the movement of the pull-tab mechanism along the x-axis such that the pull-tab mechanism is unable to move more than approximately 1.5 millimeters in the x-direction when the pull-tab mechanism is engaged. This can allow for the optical-electrical component to maintain a coupling with an external device (e.g., a network device such as a switch, router, server, etc.) such that the opto-electric components coupled to the slide mechanism are allowed to operate as intended. However, by actuating the pull handle mechanism 102 with a given amount of force, the pull-tab mechanism can be easily removed from the housing, as discussed above.

FIG. 2 illustrates a schematic structural diagram of a portion of a side of the example optical-electrical assembly. As mentioned above, the view in FIG. 2 is an enlarged, detailed view of the region 200. As shown in FIG. 2, an engagement arm 208 (which can be analogous to one of the pair of engagement arms 108 shown in FIG. 1A) and a tab 212 (which can be analogous to one of the pair of tabs 112 shown in FIG. 1A) can interface with a portion of the optical-electrical component to couple a pull-tab mechanism to the optical-electrical component, as discussed above.

In addition, as shown in FIG. 2, a recess 220 (e.g., an area that is devoid of material) is provided to the optical-electrical component. As discussed above, the vertical tab 222 indicated by the arrow “1” of FIG. 2 is provided in order to constrain the pull-tab arms in-plane by using the channel indicated by the arrow “2”of FIG. 2. Further, the travel distance in nominal “home position” is then referenced by the arrow “3” shown in FIG. 2.

FIG. 3 illustrates a schematic structural diagram of a slide component including a cantilever mechanism coupled to a pull handle mechanism associated with the optical-electrical assembly. As shown in FIG. 3, the components form the pull-tab mechanism 300 illustrated in FIG. 3. The pull handle mechanism 302 can be analogous to the pull handle mechanism 102 of FIGS. 1A-1B, the pair of engagement arms 308 can be analogous to the pair of engagement arms 108 of FIG. 1A, the pair of tabs 312 can be analogous to the pair of tabs 112 of FIG. 1A, and the cantilever mechanism 310 can be analogous to the cantilever mechanism 110 of FIG. 1B.

As shown in FIG. 3, the cantilever mechanism 310 can include a connective portion 322. The connective portion 322 can be configured to couple (e.g., “hook”) into a recess of the lower housing (e.g., the lower housing 106 of FIG. 1A) of an optical-electrical component. In addition, the cantilever mechanism can include a first hook 324-1 and a second hook 324-2. In some implementations, the first hook 324-1 and the second hook 324-2 can be configured to couple to respective recesses in the lower housing, as shown in FIGS. 4A-4B. The connective portion 322 in conjunction with the first hook 324-1 and the second hook 324-2 can serve to hold the pull-tab mechanism 300 (e.g., the pull handle mechanism 302 and the slide portion, which can include the pair of engagement arms 308 and the pair of tabs 312) to a housing, such as the housing formed by the upper housing 104 and the lower housing 106 of FIGS. 1A-1B.

FIGS. 4A-4B illustrate schematic structural diagrams of a bottom view of the cantilever mechanism. The view of the cantilever mechanism 410 illustrated in FIG. 4A shows the entire cantilever mechanism, while the view of the cantilever mechanism 410 illustrated in FIG. 4B shows a zoomed in portion of the cantilever mechanism 410 for purposes of additional clarity. The cantilever mechanism 410 illustrated in FIGS. 4A-4B can be analogous to the cantilever mechanism 110 illustrated in FIG. 1B and/or the cantilever mechanism 310 illustrated in FIG. 3, herein.

As shown in FIG. 4A, the cantilever mechanism 410 can include a connective portion 422, which can be analogous to the connective portion 322 of FIG. 3, which can couple to a portion of a lower housing 406. As will be appreciated, the lower housing 406 can be analogous to the lower housing 106 of FIGS. 1A-1B. In order to facilitate this coupling, a recess 423 (shown in FIG. 4B) can be provided in the lower housing 406. This recess 423 can be a “groove” that is manufactured with a depth and width that can accommodate the connective portion 422 thereby allowing the connective portion 422 to lock into the lower housing 406.

In addition, a first hook 424-1 and a second hook 424-2 can be included in the cantilever mechanism 410. The first hook 424-1 and the second hook 424-2 can be analogous to the first hook 324-1 and the second hook 324-2 of FIG. 3. As shown in FIG. 4A, the first hook 324-1 and the second hook 324-2 can couple to a first slot 425-1 and a second slot 425-2, respectively. It is noted that, in the view presented in FIG. 4B and with respect to the slots and hooks, only the first slot 425-1 is shown with the first hook 424-1 coupled thereto in order to more clearly elucidate the implementations described herein. Similarly, it is noted that, in the view presented in FIG. 4B, only a portion of the recess 423 is shown with a part of the connective portion 422 coupled thereto in order to more clearly elucidate the implementations described herein.

FIG. 5 illustrates a schematic structural diagram of a top view of the cantilever mechanism. The cantilever mechanism 510 illustrated in FIG. 5 can be analogous to the cantilever mechanism 110 illustrated in FIG. 1B, the cantilever mechanism 310 illustrated in FIG. 3, and/or the cantilever mechanism 410 illustrated in FIGS. 4A-4B, herein.

As shown in FIG. 5, the cantilever mechanism 510 includes a connective portion 522, which can be analogous to the connective portion 422 of FIGS. 4A-4B, as well as a first hook 524-1 and a second hook 524-2, which can be analogous to the first hook 424-1 and the second hook 424-2 of FIGS. 4A-4B.

The top view shown in FIG. 5 is from a perspective of the cantilever mechanism 510 viewed from the top down along the y-axis shown in the Figures above. It will therefore be appreciated that the view shown in FIG. 5 is a view that elucidates the structure of the connective portion 522, the first hook 524-1 and the second hook 524-2 when the connective portion 522, the first hook 524-1 and the second hook 524-2 are disengaged from the optical-mechanical component and are therefore not coupled to the lower housing discussed above.

In a non-limiting example, an apparatus in accordance with the disclosure can include an upper housing, a lower housing couplable to the upper housing, and an optical-electrical assembly enclosed by the upper housing and the lower housing. The optical-electrical assembly can include a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits. As discussed above, the apparatus can further include a pull handle mechanism coupled to the slide component and the cantilever mechanism can be configured to cause the slide component to stop at a fixed location when the slide component is engaged with the lower housing. The pull handle mechanism and the slide component are formed as a single component, as discussed above. In some implementations, the optical-electrical assembly comprises an optical transceiver.

As mentioned above, in some implementations, the plurality of opto-electric components can include at least one Transmit Optical Sub-Assembly (TOSA) and at least one Receive Optical Sub-Assembly (ROSA). Implementations are not so limited, however, and other opto-electric components discussed herein can be included in the optical-electrical assembly. In addition, in some implementations, the optical-electrical assembly can include a plurality of heat spreading components couplable to the substrate. In such implementations, when the substrate is disengaged from the optical-electrical assembly, the plurality of heat spreading components can remain coupled to the optical-electrical assembly.

As discussed above, in some implementations, the cantilever mechanism can be configured to allow for removal of the slide component through actuation of the pull handle mechanism without disengaging the upper housing from the lower housing. Similarly, the cantilever mechanism can be configured to allow for insertion of the slide component through actuation of the pull handle mechanism without disengaging the upper housing from the lower housing. In some implementations, the cantilever mechanism is configured to deflect to allow for the slide component to engage the lower housing. Further, as discussed above, in some implementations, the cantilever mechanism can be configured to cause the slide component to have approximately 1.5 millimeters or less range of motion along an axis parallel to a plane formed by a side of the upper housing having a largest area of the upper housing (e.g., along the y-axis illustrated herein).

As discussed above, the lower housing includes a plurality of slots configured to receive a plurality of hooks when the slide component is engaged with the lower housing. In addition to, or in the alternative, in some implementations, the lower housing includes a recess configured to receive the cantilever mechanism when the slide component is engaged with the lower housing. Further, as discussed above, a portion of the lower housing or a portion of the upper housing can be devoid of a material (i.e., an aperture) and can be configured to receive a tab to cause the slide component to stop at a fixed location.

In some implementations, the optical-electrical assembly can include a coupling optical system that includes an external pluggable optical interface, a coupling optical element fixedly mounted on the substrate, and a light-guiding structure optically couplable to the external pluggable optical interface and the coupling optical element. This coupling optical system can interface with an external device (e.g., a network device such as a switch, router, server, etc.).

In another non-limiting example, an optical transceiver can include a housing comprising an upper housing and a lower housing and an optical-electrical assembly insertable into the housing. The optical-electrical assembly can include a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits. The optical transceiver can further include a pull-tab mechanism that is provided as a single component that includes a pull handle mechanism, the slide component, and the cantilever mechanism. In such implementations, the cantilever mechanism can be configured to cause the slide component to interface with a recess provided in the lower housing to secure the pull-tab mechanism to the housing, as described above.

As described herein, the cantilever mechanism can be configured to deflect to allow for the pull-tab mechanism to engage the recess provided in the lower housing to secure the pull-tab mechanism to the housing. In addition, the lower housing can include a plurality of slots configured to receive a plurality of hooks associated with the pull-tab mechanism when the slide component is engaged with the housing. As discussed above, the cantilever mechanism can be configured to allow for removal of the pull-tab mechanism through actuation of the pull handle mechanism without opening the housing (e.g., without removing the upper housing from the lower housing or vice versa).

In some implementations, a portion of the lower housing or a portion of the upper housing can be devoid of a material and can be configured to receive a tab to cause the pull-tab mechanism to stop at a fixed location. In these and other implementations, the cantilever mechanism can be configured to cause the pull-tab mechanism to have 1.5 millimeters or less range of motion along an axis parallel to an axis of insertion of the pull-tab mechanism into the housing.

As discussed above, in some implementations, the opto-electric components include at least one opto-electric component selected from a list consisting of: a Transmit Optical Sub-Assembly (TOSA), a Receive Optical Sub-Assembly (ROSA), one or more heat spreading components, functional circuit components, optical bores, laser diodes, light-emitting diodes, photodetector diodes, an in-module gearbox, in-module forward error correction components, high bandwidth integrated polarization multiplexed quadrature modulators, integrated polarization multiplexed quadrature modulated transmitters, and/or integrated dual polarization micro-intradyne coherent receivers.

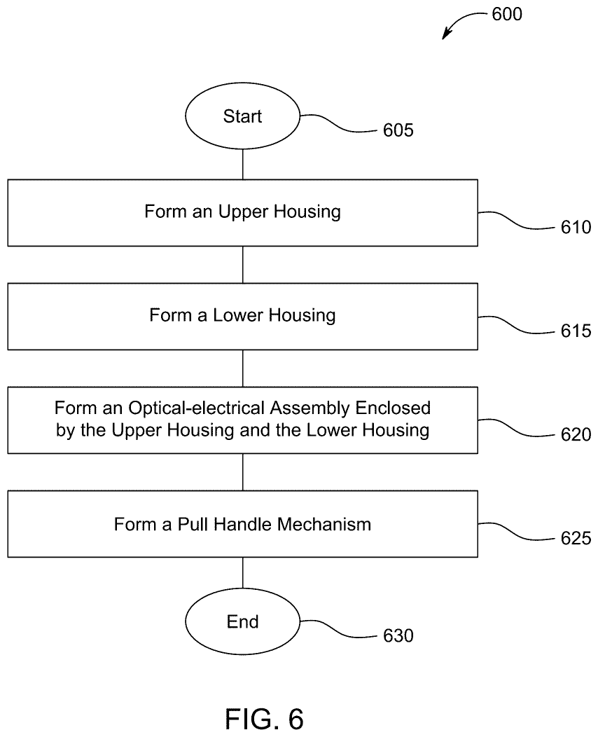

In closing, FIG. 6 illustrates an example simplified procedure for forming a cantilever constraining feature for an optical transceiver module in accordance with one or more embodiments described herein. The procedure 600 (e.g., a method) may start at step 605, and continues to step 610, where, as described in greater detail above, an upper housing is formed.

The procedure 600 may continue to step 615 where, as described above, a lower housing is formed. The upper housing and the lower housing may be coupled together to form a housing, as discussed in more detail herein.

The procedure 600 may continue to step 620 where, as described above, an optical-electrical assembly enclosed by the upper housing and the lower housing is formed. As described above, the optical-electrical assembly can include a slide component including a cantilever mechanism, a substrate coupled to the slide component, a plurality of opto-electric components disposed on the substrate, interface integrated circuits disposed on the substrate, and a pluggable electrical interface disposed on the substrate and electrically couplable to the interface integrated circuits.

The procedure 600 may continue to step 625 where, as described above, a pull handle mechanism is formed. The pull handle mechanism can be coupled to the slide component and the cantilever mechanism can be configured to cause the slide component to stop at a fixed location when the slide component is engaged with the lower housing.

Procedure 600 may end at step 630.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for a cantilever constraining feature for an optical transceiver module. More specifically, the techniques herein provide for a cantilever mechanism that creates a hard-stop for a sliding mechanism (e.g., a slide component) used on an optical-electrical component, such as an optical transceiver module. This can reduce complexity in enclosure design of mating components, free up critical real estate in the mechanical enclosure of the optical-electrical component and allow for assembly and/or disassembly of the mechanism (e.g., access to components located inside the enclosure) when the enclosure is assembled.

While there have been shown and described illustrative implementations above, it is to be understood that various other adaptations and modifications may be made within the scope of the implementations herein. For example, while certain implementations are described herein with respect to certain types of optical-electrical components in particular, the techniques are not limited as such and may be used with any optical-electrical component, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A apparatus, comprising:
an upper housing;
a lower housing couplable to the upper housing;
an optical-electrical assembly enclosed by the upper housing and the lower housing, the optical-electrical assembly comprising:
a slide component including a cantilever mechanism;
a substrate coupled to the slide component;
a plurality of opto-electric components disposed on the substrate;
interface integrated circuits disposed on the substrate; and
a pluggable electrical interface disposed on the substrate and electrically couplable to the interface integrated circuits; and
a pull handle mechanism coupled to the slide component, wherein the cantilever mechanism is configured to cause the slide component to stop at a fixed location when the slide component is engaged with the lower housing.

2. The apparatus of claim 1, wherein the plurality of opto-electric components comprise at least one Transmit Optical Sub-Assembly (TOSA) and at least one Receive Optical Sub-Assembly (ROSA).

3. The apparatus of claim 1, wherein the optical-electrical assembly further comprises a plurality of heat spreading components couplable to the substrate, wherein, when the substrate is disengaged from the optical-electrical assembly, the plurality of heat spreading components remain coupled to the optical-electrical assembly.

4. The apparatus of claim 1, wherein the cantilever mechanism is configured to allow for removal of the slide component through actuation of the pull handle mechanism without disengaging the upper housing from the lower housing.

5. The apparatus of claim 1, wherein the cantilever mechanism is configured to deflect to allow for the slide component to engage the lower housing.

6. The apparatus of claim 1, wherein the cantilever mechanism is configured to cause the slide component to have 1.5 millimeters or less range of motion along an axis parallel to a plane formed by a side of the upper housing having a largest area of the upper housing.

7. The apparatus of claim 1, wherein the optical-electrical assembly comprises an optical transceiver.

8. The apparatus of claim 1, further comprising:
a coupling optical system comprising an external pluggable optical interface, a coupling optical element fixedly mounted on the substrate, and a light-guiding structure optically couplable to the external pluggable optical interface and the coupling optical element.

9. The apparatus of claim 1, wherein the lower housing includes a plurality of slots configured to receive a plurality of hooks when the slide component is engaged with the lower housing.

10. The apparatus of claim 1, wherein the lower housing includes a recess configured to receive the cantilever mechanism when the slide component is engaged with the lower housing.

11. The apparatus of claim 1, wherein a portion of the lower housing or a portion of the upper housing is devoid of a material and is configured to receive a tab to cause the slide component to stop at a fixed location.

12. The apparatus of claim 1, wherein the pull handle mechanism and the slide component are formed as a single component.

13. An optical transceiver, comprising:
a housing comprising an upper housing and a lower housing;
an optical-electrical assembly insertable into the housing, the optical-electrical assembly comprising:
a slide component including a cantilever mechanism;
a substrate coupled to the slide component;
a plurality of opto-electric components disposed on the substrate;
interface integrated circuits disposed on the substrate; and
a pluggable electrical interface disposed on the substrate and electrically couplable to the interface integrated circuits; and
a pull-tab mechanism comprising a pull handle mechanism, the slide component, and the cantilever mechanism, wherein the cantilever mechanism is configured to cause the slide component to interface with a recess provided in the lower housing to secure the pull-tab mechanism to the housing.

14. The optical transceiver of claim 13, wherein the cantilever mechanism is configured to deflect to allow for the pull-tab mechanism to engage the recess provided in the lower housing to secure the pull-tab mechanism to the housing.

15. The optical transceiver of claim 13, wherein the lower housing includes a plurality of slots configured to receive a plurality of hooks associated with the pull-tab mechanism when the slide component is engaged with the housing.

16. The optical transceiver of claim 13, wherein a portion of the lower housing or a portion of the upper housing is devoid of a material and is configured to receive a tab to cause the pull-tab mechanism to stop at a fixed location.

17. The optical transceiver of claim 13, wherein the cantilever mechanism is configured to cause the pull-tab mechanism to have 1.5 millimeters or less range of motion along an axis parallel to an axis of insertion of the pull-tab mechanism into the housing.

18. The optical transceiver of claim 13, wherein the plurality of opto-electric components include at least one opto-electric component selected from a list consisting of: a Transmit Optical Sub-Assembly (TOSA), a Receive Optical Sub-Assembly (ROSA), one or more heat spreading components, functional circuit components, optical bores, laser diodes, light-emitting diodes, photodetector diodes, an in-module gearbox, in-module forward error correction components, high bandwidth integrated polarization multiplexed quadrature modulators, integrated polarization multiplexed quadrature modulated transmitters, and integrated dual polarization micro-intradyne coherent receivers.

19. The optical transceiver of claim 13, wherein the cantilever mechanism is configured to allow for removal of the pull-tab mechanism through actuation of the pull handle mechanism without opening the housing.

20. A method comprising:
forming an upper housing;
forming a lower housing couplable to the upper housing;
forming an optical-electrical assembly enclosed by the upper housing and the lower housing, the optical-electrical assembly comprising:
a slide component including a cantilever mechanism;
a substrate coupled to the slide component;
a plurality of opto-electric components disposed on the substrate;
interface integrated circuits disposed on the substrate; and
a pluggable electrical interface disposed on the substrate and electrically couplable to the interface integrated circuits; and
forming a pull handle mechanism coupled to the slide component, wherein the cantilever mechanism is configured to cause the slide component to stop at a fixed location when the slide component is engaged with the lower housing.
